(19) United States
(12) Patent Application Publication
(10) Pub. No.: US 2011/0093625 A1
(43) Pub. Date: Apr. 21, 2011

(54) STORAGE SYSTEM, CONTROL DEVICE, AND DIAGNOSIS METHOD

(75) Inventor: Yusuke YONEDA, Kahoku (JP)

(73) Assignee: FUJITSU LIMITED, Kawasaki-shi (JP)

(21) Appl. No.: 12/903,641

(22) Filed: Oct. 13, 2010

(30) Foreign Application Priority Data
Oct. 19, 2009 (JP) 2009-240572

(51) Int. Cl. G06F 3/00

(52) U.S. Cl. 710/19

(57) ABSTRACT

A storage system continues its operation to reduce the influence on a wide link by abnormal physical wiring and so as not to lose the redundancy of the system. At least one physical wiring line is selected from among two or more physical wiring lines, the selected physical wiring line is invalidated, the presence of an abnormal transmission line generation is confirmed in the data transfer that uses physical wiring line other than the invalidated physical wiring line, and when the abnormal transmission line is confirmed, the selected physical wiring line is recognized normal wiring line.

### CROSS-REFERENCE TO RELATED APPLICATION

This application is based upon and claims the benefit of priority of the prior Japanese Patent Application No. 2009-240572, filed on Oct. 19, 2009, the entire contents of which are incorporated herein by reference.

### FIELD

The present invention relates to a technique in which a physical wiring included in parallel wiring lines used for connecting a storage device is diagnosed.

### BACKGROUND

In recent years, there has been known a data storage system in which a drive enclosure internally equipped with a serial attached SCSI (SAS) expander is connected using a wide link (refer to Japanese Laid-open Patent Publication No. 2007-256993).

Here, a wide link is a wiring line including a plurality of physical wiring lines (abbreviated by PHY: physical link) that are arranged in parallel.

FIG. 10 is a diagram illustrating the configuration of a storage system that includes a plurality of drive enclosures.

A data storage system 100 shown in FIG. 10 includes a controller enclosure 101 and drive enclosures 102-1 and 102-2. In addition, in the data storage system 100, a plurality of drive enclosures (two drive enclosures 102-1 and 102-2, in the example shown in FIG. 10) are cascade-connected to the controller enclosure 101.

The controller enclosure 101 is connected to a higher-level device (server computer or the like), which is not shown in FIG. 10, and performs various kinds of control operations such as an access control operation for a hard disk drive (HDD) 105 described later, or the like, in accordance with a storage access request (referred to as host input/output (I/O), hereinafter) from the higher-level device.

As shown in FIG. 10, the controller enclosure 101 includes controller modules 111a and 111b and the HDD 105.

The controller modules 111a and 111b perform various kinds of control operations, and have configurations similar to each other.

Each of the controller modules 111a and 111b includes a redundant arrays of inexpensive disks (RAID) controller 112 and an SAS expander 104.

The RAID controller 112 performs a control operation relating to the realization of a RAID function. The SAS expander 104 performs relay functions between the RAID controller 112 and the HDD 105, and performs data transfer on the basis of a host I/O. Namely, the RAID controller 112 accesses the HDD 105 arranged in the data storage system 100 through the SAS expander 104.

The HDD 105 is a memory device used for storing data in such a way that the data can be read and written.

In the example shown in FIG. 10, five HDDs 105 are arranged, and have configurations similar to each other.

In addition, each of the HDDs 105 is connected to each of the SAS expanders 104 in the controller modules 111a and 111b.

In addition, in the controller enclosure 101, the RAID controller 112 is individually connected to the SAS expander 104 in the same controller module 111a (111b) and the SAS expander 104 in the other controller module 111b (111a).

The drive enclosures 102-1 and 102-2 include a plurality of HDDs 105 (five HDDs 105 in the example shown in FIG. 10) and provide the storage areas of these HDDs 105. The drive enclosures 102-1 and 102-2 have configurations similar to each other, and each of the drive enclosures 102-1 and 102-2 includes expander modules 103a and 103b and five HDDs 105.

In addition, hereinafter, since, in figures, a symbol, identical to a symbol that has already been mentioned, indicates the same or almost the same portion, the detailed description thereof will be omitted.

In addition, the expander modules 103a and 103b have configurations similar to each other, and individually include the SAS expanders 104. In addition, in the drive enclosures 102-1 and 102-2, each of the HDDs 105 is connected to each of the SAS expanders 104 in the expander modules 103a and 103b.

In addition, the drive enclosure 102-1 is connected to the controller enclosure 101 through wide links 201a-1 and 201b-1. In addition, the drive enclosure 102-2 is connected to the drive enclosure 102-1 through wide links 201a-2 and 201b-2.

In more detail, through the wide link 201a-1, the SAS expander 104 arranged in the expander module 103a in the drive enclosure 102-1 is connected to the SAS expander 104 arranged in the controller module 111a in the controller enclosure 101.

In the same way, through the wide link 201b-1, the SAS expander 104 arranged in the expander module 103b in the drive enclosure 102-1 is connected to the SAS expander 104 arranged in the controller module 111b in the controller enclosure 101.

In addition, through the wide link 201a-2, the SAS expander 104 arranged in the expander module 103a in the drive enclosure 102-2 is connected to the SAS expander 104 arranged in the expander module 103a in the drive enclosure 102-1.

In the same way, through the wide link 201b-2, the SAS expander 104 arranged in the expander module 103b in the drive enclosure 102-2 is connected to the SAS expander 104 arranged in the expander module 103b in the drive enclosure 102-1.

Namely, the drive enclosures 102-1 and 102-2 are cascade-connected to the controller enclosure 101 through the wide links 201a-1, 201b-1, 201a-2, and 201b-2.

In addition, SAS expanders 104 arranged in the expander modules 103a and 103b in the drive enclosure 102-2 are connected to other devices (not shown in figures) through wide links 201a-3 and 201b-3, respectively.

In addition, hereinafter, while, as symbols indicating wide links, symbols 201a-1, 201b-1, 201a-2, and 201b-2 are used when it is necessary to specify one of a plurality of wide links, a symbol 201 is used when an arbitrary wide link is indicated.

The wide link 201 is a communication line including a plurality of PHYs (for example, four PHYs) that function as physical wiring lines (physical links) and are bundled in parallel. In addition, in the data storage system 100, a host I/O or the like from the higher-level device is transmitted through one of the PHYs on the wide link 201.

The data storage system mentioned above has a redundant configuration by arranging the controller modules 111a and 111b and the expander modules 103a and 103b that have similar configurations. Accordingly, the performance and efficiency of the data storage system can be improved owing to I/O load distribution, and a component in which a failure occurs in a system operating status can be replaced owing to the redundancy.

In the data storage system 100 including the wide link 201 configured in the way mentioned above, a PHY used as a transmission path for a host I/O is typically selected by the SAS expander 104, and it is difficult for an initiator to specify a PHY used for data transfer.

Accordingly, in a technique of the related art, even if a malfunction occurs in one of PHYs on the wide link 201 and hence the transmission error of a host I/O occurs, it is difficult to specify the malfunctioning PHYs.

FIGS. 11A and 11B are diagram illustrating a case in which a malfunction occurs in one of PHYs on the wide link 201b-1.

Here, as shown in FIG. 11A, when a malfunction occurs in one of PHYs on the wide link 201b-1, errors turn out to irregularly occur in a host I/O that uses the wide link 201b-1 as a path. Namely, in the example shown in FIGS. 11A and 11B, owing to the malfunction of the PHYs on the wide link 201b-1, the controller modules 111a and 111b irregularly detect errors in the host I/O for the SAS expander 104 in the drive enclosure 103b.

In the data storage system 100 of the related art, for example, when a plurality of errors (transmission path malfunctions) are detected in a host I/O for a specific SAS expander 104, the SAS expander 104 is degenerated as a malfunctioning component.

In this way, when the SAS expander 104 is degenerated, the redundancy of the system is lost, and the performance and efficiency of the host I/O decreases by half.

Accordingly, if the degeneracy of the SAS expander 104 is frequently performed, there occurs a problem that the performance of the data storage system 100 is greatly reduced. Accordingly, in the operation of the data storage system 100, a system administrator desires to reduce the degeneracy of the SAS expander 104 as much as possible.

### SUMMARY

There is provided a storage system according to an embodiment of the present invention, wherein the storage system includes a storage device in which a memory device is arranged and the storage device is connected using parallel wiring lines in which a plurality of physical wiring lines are arranged in parallel, the storage system including a selection section configured to select, as a physical wiring line under selection, at least one of the plurality of physical wiring lines; an invalidation section configured to invalidate the physical wiring line under selection; a confirmation section configured to confirm whether or not a transmission path malfunction has occurred in the transfer of data, which uses a physical wiring line other than the invalidated physical wiring line under selection; and a certification section configured to certify the physical wiring line under selection as a normally functioning wiring line when the confirmation section confirms the occurrence of the transmission path malfunction.

There is provided a control device according to an embodiment of the present invention, wherein the control device is connected to a storage device, in which a memory device is arranged, through parallel wiring lines in which a plurality of physical wiring lines are arranged in parallel, the control device including a selection section configured to select, as a physical wiring line under selection, at least one of the plurality of physical wiring lines; an invalidation section configured to invalidate the physical wiring line under selection; a confirmation section configured to confirm whether or not a transmission path malfunction has occurred in the transfer of data, which uses a physical wiring line other than the invalidated physical wiring line under selection; and a certification section configured to certify the physical wiring line under selection as a normally functioning wiring line when the confirmation section confirms the occurrence of the transmission path malfunction.

There is provided a diagnosis method according to an embodiment of the present invention, wherein the diagnosis method is performed in a storage system where a storage device in which a memory device is arranged is included and the storage device is connected using parallel wiring lines in which a plurality of physical wiring lines are arranged in parallel, the diagnosis method including the steps of selecting, as a physical wiring line under selection, at least one of the plurality of physical wiring lines; invalidating the physical wiring line under selection; confirming whether or not a transmission path malfunction has occurred in the transfer of data, which uses a physical wiring line other than the invalidated physical wiring line under selection; and certifying the physical wiring line under selection as a normally functioning wiring line when the occurrence of the transmission path malfunction is confirmed in the confirmation step.

As mentioned above, owing to the storage system, the control device, and the diagnosis method, disclosed, the effect of a malfunctioning physical wiring line on a wide link is reduced and the operability of a system can be maintained with the redundancy thereof not being lost.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional structure of a storage system according to an embodiment of the present invention;

FIG. 2 is a diagram illustrating an example of a hardware configuration of a storage system according to an embodiment of the present invention;

FIG. 3 is a diagram illustrating a diagnosis method for a PHYs, performed in a storage system according to an embodiment of the present invention;

FIG. 4 is a diagram illustrating a diagnosis method for a PHYs, performed in a storage system according to an embodiment of the present invention;

FIG. 5 is a diagram illustrating a diagnosis method for a PHYs, performed in a storage system according to an embodiment of the present invention;

FIG. 6 is a diagram illustrating a state in which an isolation operation is performed in a storage system according to an embodiment of the present invention;

FIG. 7 is a flowchart illustrating a diagnosis method for a PHY, performed in a storage system according to an embodiment of the present invention;

FIG. 8 is a flowchart illustrating a processing operation performed when a transmission path malfunction occurs during an operation of a storage system according to an embodiment of the present invention;

FIGS. 9A to 9E are diagrams illustrating a modified example of a diagnosis method for a PHY, performed in a storage system according to an embodiment of the present invention;

FIG. 10 is a diagram illustrating a hardware configuration of a storage system including a plurality of drive enclosures; and

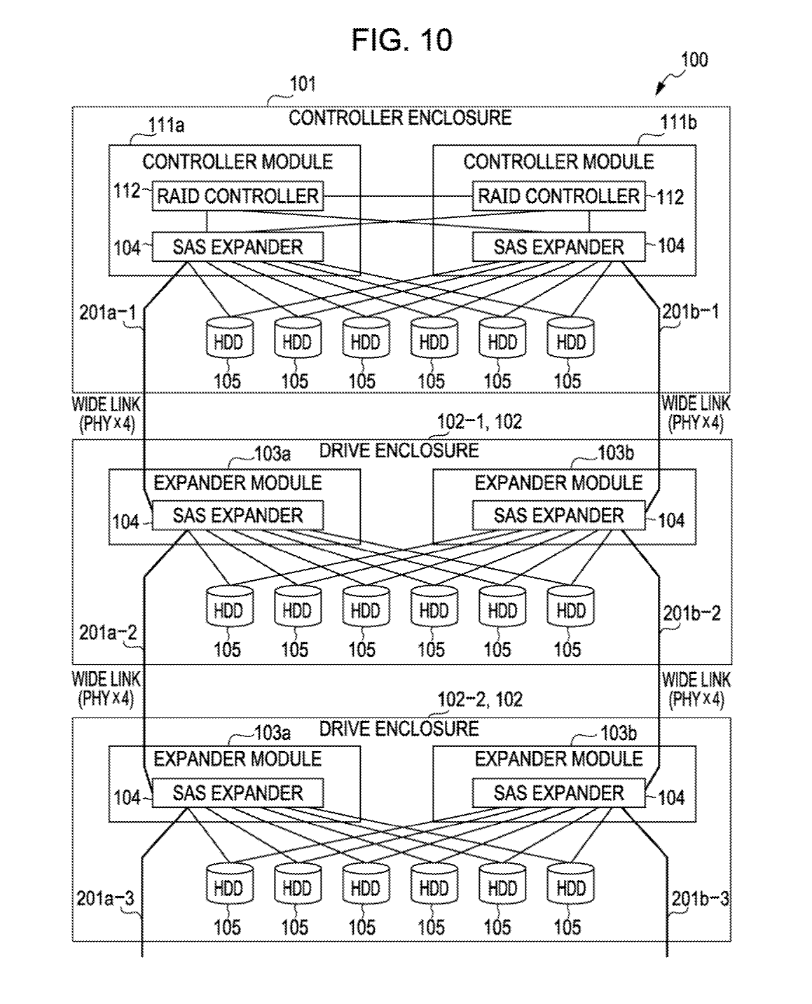

FIGS. 11A and 11B are diagram illustrating a case in which a malfunction occurs in one of PHYs on a wide link.

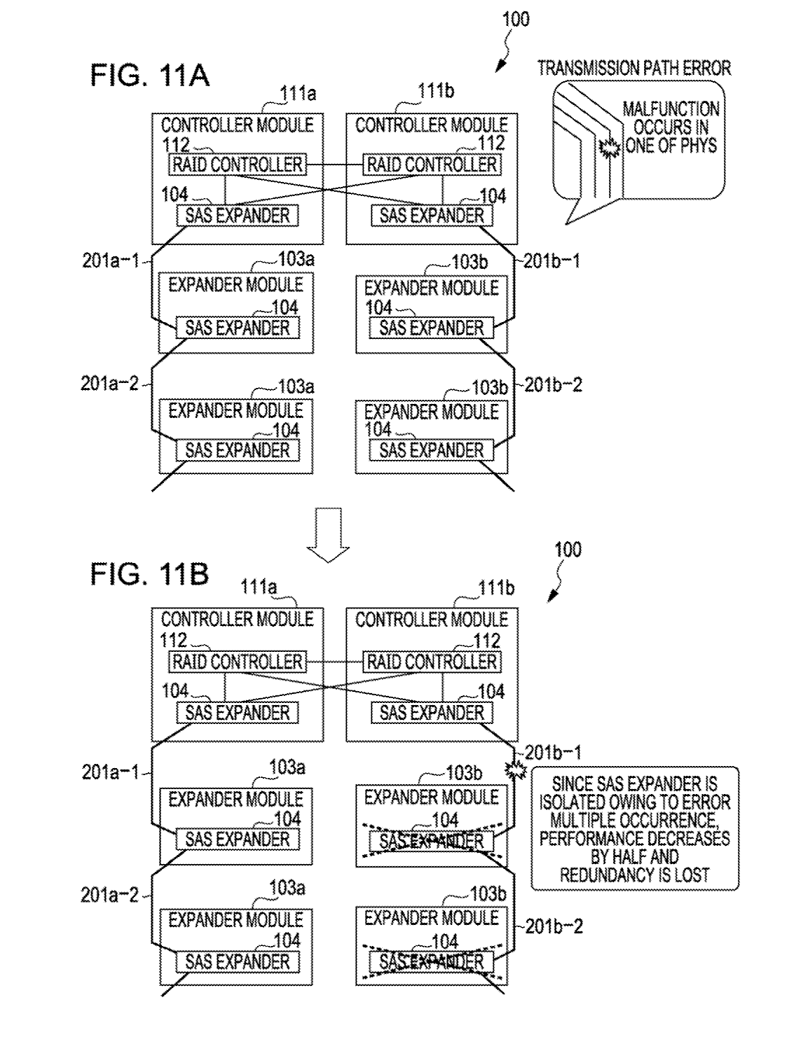

### DESCRIPTION OF EMBODIMENTS

Hereinafter, embodiments of the present invention will be described in detail with reference to figures.

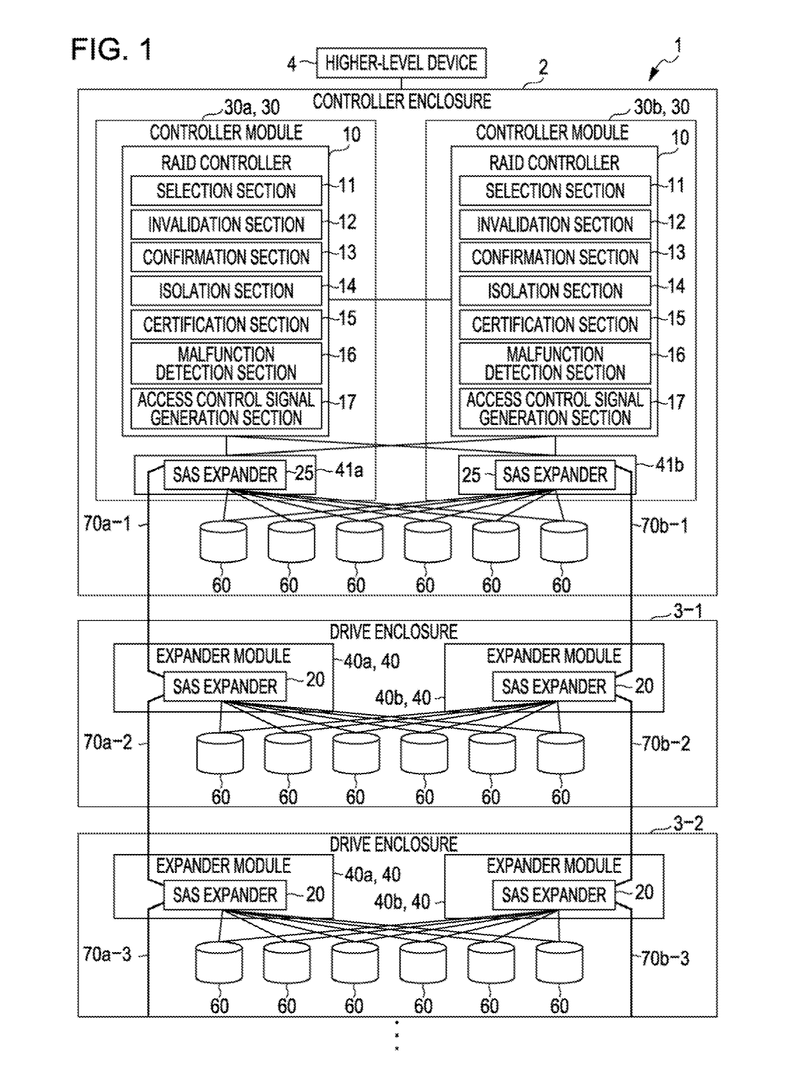

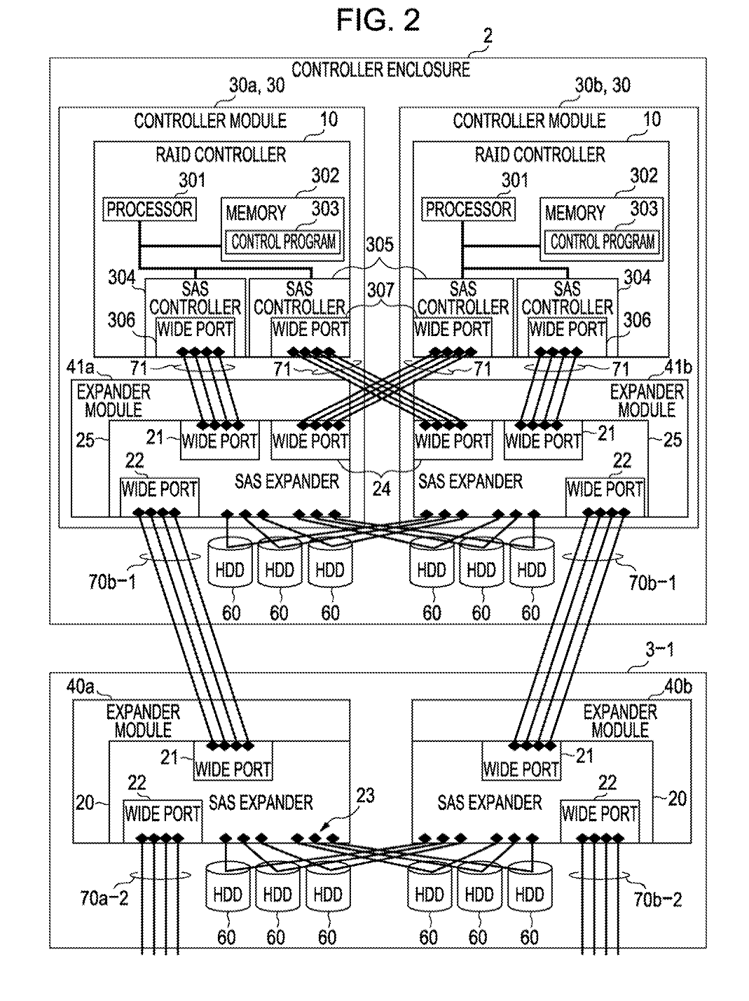

FIG. 1 is a diagram illustrating an example of the functional structure of a storage system according to an embodiment of the present invention. In addition, FIG. 2 is a diagram illustrating an example of the hardware configuration of the storage system.

As shown in FIG. 1, a storage system 1 according to the embodiment is connected to one or more higher-level devices 4 (one higher-level device 4 in the example shown in FIG. 1), and provides a storage area for the higher-level devices 4. In addition, the higher-level devices 4 are, for example, computers (for information processing) including server functions.

The storage system 1 includes a controller enclosure 2 and drive enclosures 3-1 and 3-2. In the storage system 1, a plurality of drive enclosures (two drive enclosures 3-1 and 3-2 in the example shown in FIG. 1) are cascade-connected to the controller enclosure 2 through wide links 70a-1, 70b-1, 70a-2, and 70b-2.

The wide links 70a-1, 70b-1, 70a-2, and 70b-2 are communication lines including a plurality of PHYs (four PHYs in the example: refer to FIG. 2) that function as physical wiring lines (physical links) and are bundled in parallel. In addition, the wide links 70a-1, 70b-1, 70a-2, and 70b-2 connect SAS expanders 20 to one another so that the SAS expanders 20 can communicate with one another. In addition, hereinafter, while, as symbols indicating wide links, symbols 70a-1, 70b-1, 70a-2, and 70b-2 are used when it is necessary to specify one of a plurality of wide links, a symbol 70 is used when an arbitrary wide link is indicated.

In addition, in the storage system 1, a host I/O or the like from the higher-level device 4 is transmitted through one of the PHYs on the wide link 70.

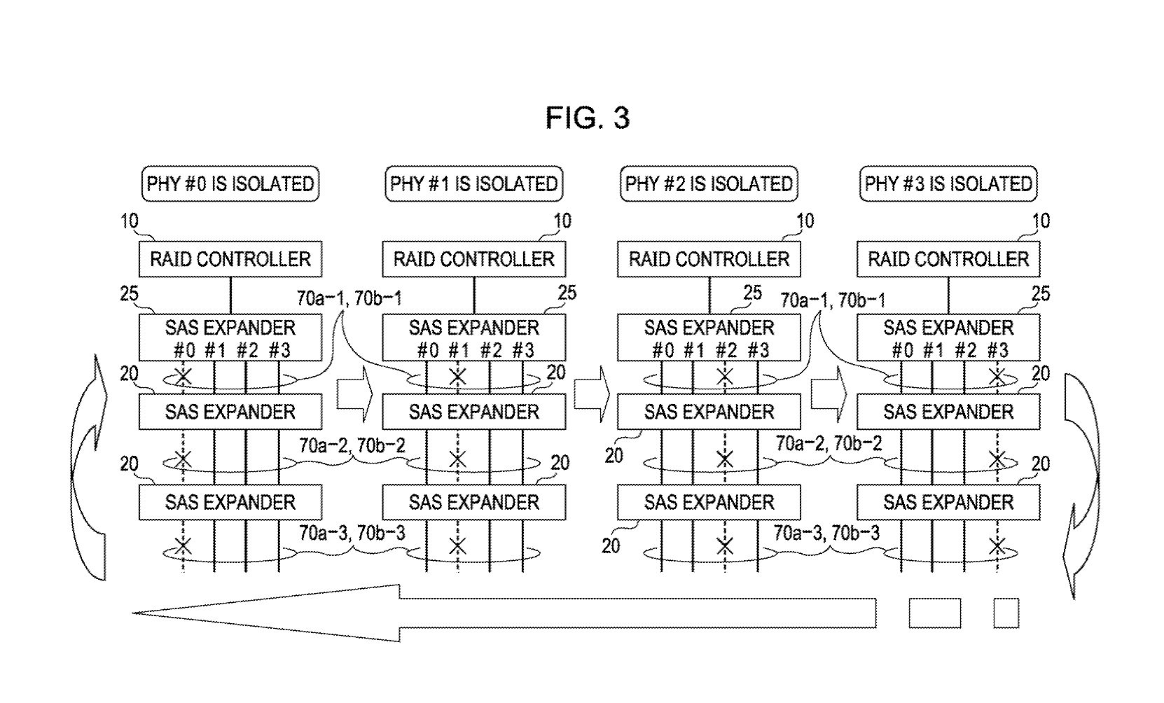

Hereinafter, in the embodiment, in some cases, four PHYs included in the wide link 70 are specified using symbols #0 to #3 (refer to FIGS. 3 to 5).

The drive enclosures 3-1 and 3-2 individually include a plurality of HDDs 60 (six HDDs in the examples shown in FIGS. 1 and 2), and provide the storage areas of the HDDs 60 so that the storage areas of the HDDs can be used.

The drive enclosures 3-1 and 3-2 have configurations similar to each other, and each of the drive enclosure 3-1 and 3-2 includes expander modules 40a and 40b and six HDDs 60.

In addition, hereinafter, while, as symbols indicating drive enclosures, symbols 3-1 and 3-2 are used when it is necessary to specify one of a plurality of drive enclosures, a symbol 3 is used when an arbitrary drive enclosure is indicated.

In addition, the expander modules 40a and 40b have configurations similar to each other, and individually include the SAS expanders 20. In addition, in each drive enclosure 3, each of the HDDs 60 is connected to each of the SAS expanders 20 in the expander modules 40a and 40b.

Hereinafter, while, as symbols indicating expander module, symbols 40a and 40b are used when it is necessary to specify one of a plurality of expander modules, a symbol 4 is used when an arbitrary expander module is indicated.

In addition, since a symbol, identical to a symbol that has already been mentioned in figures, indicates the same or almost the same portion, the detailed description thereof will be omitted.

The SAS expander 20 performs relay functions between the RAID controller 10 and the HDD 60, and performs data transfer on the basis of a host I/O. Namely, the RAID controller 10 accesses the HDD 60 arranged in the data storage system 1 through the SAS expander 20.

As shown in FIG. 2, the SAS expander 20 includes wide ports 21 and 22 and storage port 23. The storage port 23 includes a plurality of ports (six ports in the example shown in FIG. 2), and the ports are connected to the HDDs 60 arranged in the same drive enclosure 3, respectively.

The wide ports 21 and 22 are ports used for connecting the SAS expander 20, in which the wide ports 21 and 22 are arranged, to another SAS expander 20, and the wide links 70 are individually connected to the wide ports 21 and 22. Namely, the same number of ports as PHYs arranged on the wide link 70 (four PHYs #0 to #3 in the embodiment) are arranged in the wide ports 21 and 22, and PHYs arranged on the wide link 70 are connected to the ports, respectively. Namely, the wide ports 21 and 22 are arranged so as to correspond to the PHYs #0 and #3.

The wide port 21 is connected to a wide port 22 arranged in another SAS expander 20 on a side near to the higher-level device 4 (in some cases, referred to as upstream side, hereinafter) through the wide link 70. In addition, the wide port 22 is connected to a wide port 21 arranged in another SAS expander 20 on a side away from the higher-level device 4 (in some cases, referred to as downstream side, hereinafter) through the wide link 70.

The HDD 60 is a memory device used for storing data in such a way that the data can be read and written. In the example shown in FIG. 1, six HDDs 60 are arranged, and have configurations similar to one another. In addition, each of the HDDs 60 is connected to each of the SAS expanders 20 in the expander module 40a and 40b so that each of the HDDs 60 can communicate with each of the SAS expanders 20.

The controller enclosure 2 is connected to the higher-level device 4, and a plurality of drive enclosures (two drive enclosures 3-1 and 3-2 in the example shown in FIG. 1) are cascade-connected to the controller enclosure 2.

As shown in FIG. 1, the controller enclosure 2 includes controller modules 30a and 30b and HDDs 60.

The controller modules 30a and 30b are devices that perform various kinds of control operations, and perform various kinds of control operations such as an access control operation for the HDDs 60, described hereinafter, or the like, in accordance with a storage access request (access control signal: referred to as host I/O, hereinafter) from the higher-level device 4. In addition, the controller modules 30a and 30b have configurations similar to each other. The controller module 30a includes a RAID controller (control device) 10 and an expander module 41a, and the controller module 30b includes a RAID controller 10 and an expander module 41b.

In addition, hereinafter, while, as symbols indicating controller modules, symbols 30a and 30b are used when it is necessary to specify one of a plurality of controller modules, a symbol 30 is used when an arbitrary controller module is indicated.

The drive enclosure 3-1 is connected to the controller enclosure 2 through the wide links 70a-1 and 70b-1. In addition, the drive enclosure 3-2 is connected to the drive enclosure 3-1 though wide links 70a-2 and 70b-2.

In more detail, the SAS expander 20 arranged in the expander module 40a in the drive enclosure 3-1 is connected to an SAS expander 25 arranged in the controller module 30a in the controller enclosure 2 through the wide link 70a-1. In the same way, the SAS expander 20 arranged in the expander module 40b in the drive enclosure 3-1 is connected to an SAS expander 25 arranged in the controller module 30b in the controller enclosure 2 through the wide link 70b-1.

In addition, the SAS expander 20 arranged in the expander module 40a in the drive enclosure 3-2 is connected to the SAS expander 20 arranged in the expander module 40a in the drive enclosure 3-1 through the wide link 70a-2. In the same way, the SAS expander 20 arranged in the expander module 40b in the drive enclosure 3-2 is connected to the SAS expander 20 arranged in the expander module 40b in the drive enclosure 3-1 through the wide link 70b-2.

Namely, the drive enclosures 3-1 and 3-2 are cascade-connected to the controller enclosure 2 through the wide links 70a-1, 70b-1, 70a-2, and 70b-2.

In addition, the SAS expanders 20 arranged in the expander modules 40a and 40b in the drive enclosure 3-2 are connected other devices (not shown in figures) through the wide links 70a-3 and 70b-3, respectively.

In addition, in the controller enclosure 2, the RAID controller 10 is connected to the SAS expanders 25 in the same controller module 30a (30b) and the SAS expanders 25 in the other controller module 30b (30a).

The RAID controller 10 realizes a RAID function and performs various kinds of control operations, and, as shown in FIG. 2, includes a processor 301, a memory 302, and SAS controllers 304 and 305.

The memory 302 is a memory device that records various kinds of programs and data, and data or the like is temporarily recorded and deployed in the memory 302 when the processor 301 performs an arithmetic processing operation.

The SAS controllers 304 and 305 perform various kinds of control operations relating to SAS, and the SAS controllers 304 and 305 include the wide ports 306 and 307, respectively. The wide ports 306 and 307 are ports used for individually connecting the SAS controllers 304 and 305 to the SAS expanders 25 so that the SAS controllers 304 and 305 can communicate with the SAS expanders 25, and the wide links 71 are individually connected to the wide ports 306 and 307.

In the same way as the wide link 70, the wide link 71 is a communication line including a plurality of PHYs (four PHYs in the embodiment: refer to FIG. 2) that function as physical wiring lines (physical links) and are bundled in parallel.

Namely, the same number of ports as PHYs arranged on the wide link 71 (four PHYs in the embodiment) are arranged in the wide port 306 and 307, and PHYs arranged on the wide link 71 are connected to the ports, respectively.

The wide port 306 is connected to the wide port 21 arranged in the SAS expander 25 in the same controller module 30a (30b) through the wide link 71. In addition, the wide port 307 is connected to the wide port 21 arranged in the SAS expander 25 in the other controller module 30b (30a) through the wide link 71.

Accordingly, the RAID controller 10 in the controller module 30a can be connected to both the SAS expander 25 in the controller module 30a in which the RAID controller 10 is arranged and the SAS expander 25 in the other controller module 30b. In the same way, the RAID controller 10 in the controller module 30b can be connected to both the SAS expander 25 in the controller module 30b in which the RAID controller 10 is arranged and the SAS expander 25 in the other controller module 30a.

In addition, in the storage system 1, the expander module 40a in the drive enclosure 3-1 is connected to the downstream side of the controller module 30a through the wide link 70a-1. Furthermore, the expander module 40a in the drive enclosure 3-2 is connected to the downstream side of the expander module 40a in the drive enclosure 3-1 through the wide link 70a-2.

Hereinafter, in some cases, a straight path in which the controller module 30a is located upstream and the wide links 70a-1, 70a-2, and 70a-3 are included is expressed as an a-system. In addition, in the embodiment, devices or the like included in the a-system are indicated with a character “a” being included in symbols corresponding to the devices or the like.

In addition, in the storage system 1, the expander module 40b in the drive enclosure 3-1 is connected to the downstream side of the controller module 30b through the wide link 70b-1. Furthermore, the expander module 40b in the drive enclosure 3-2 is connected to the downstream side of the expander module 40b through the wide link 70b-2. Hereinafter, in some cases, a straight path in which the controller module 30b is located upstream and the wide links 70b-1, 70b-2, and 70b-3 are included is expressed as a b-system. In addition, in the embodiment, devices or the like included in the b-system are indicated with a character “b” being included in symbols corresponding to the devices or the like.

The expander modules 41a and 41b have configurations similar to each other and individually include the SAS expanders 25.

In the same way as the SAS expander 20, the SAS expander 25 performs relay functions between the RAID controller 10 and both the SAS expander 20 and the HDD 60, and performs data transfer on the basis of a host I/O. The SAS expander 25 has a configuration similar to the configuration of the SAS expander 20, and further includes the wide port 24.

The wide port 24 is connected to the wide port 307 arranged in the SAS controller 305 in the RAID controller 10 arranged in the other system, and hence the RAID controller 10 in the controller module 30a and the SAS expander 25 in the controller module 30b are connected to each other so that the RAID controller 10 in the controller module 30a and the SAS expander 25 in the controller module 30b can communicate with each other (cross connection). In the same way, the RAID controller 10 in the controller module 30b and the SAS expander 25 in the controller module 30a are connected to each other so that the RAID controller 10 in the controller module 30b and the SAS expander 25 in the controller module 30a can communicate with each other.

The processor 301 performs various kinds of arithmetic operations and control operations, and, by executing an arithmetic program 303 stored in the memory 302, realizes various functions performed in the storage system 1.

For example, the processor 301 realizes various kinds of functions as a well-known RAID controller, such as the realization of the RAID function and an access control operation for the HDD 60, which is performed in response to a host I/O from the higher-level device 4, or the like.

In addition, in the storage system, the RAID controller 10 includes a diagnosis function for diagnosing whether or not data communication can be performed using individual PHY included in the wide link 70.

Specifically, by executing the control program 303, the processor 301 functions as a selection section 11, an invalidation section 12, a confirmation section 13, an isolation section 14, an access control signal generation section 17, a certification section 15, and a malfunction detection section 16, described later.

In addition, a program (control program 303) used for realizing the individual functions is provided in such a form that the program is recorded on a computer-readable recording medium such as, for example, a flexible disk, a CD (CD-ROM, CD-R, CD-RW or the like), a DVD (DVD-ROM, DVD-RAM, DVD-R, DVD+R, DVD-RW, DVD+RW, HD DVD or the like), a blue-ray disc, a magnetic disk, an optical disk, a magneto optical disk or the like. In addition, a computer reads out the program from the recording medium, transfers and stores the read program to and in an internal memory device or an external memory device, and uses the program. In addition, the program may be recorded in a memory device (recording medium) such as, for example, a magnetic disk, an optical disk, a magneto optical disk or the like, and be provided from the memory device to the computer through a communication path.

When functions of the selection section 11, the invalidation section 12, the confirmation section 13, the isolation section 14, the access control signal generation section 17, the certification section 15, and the malfunction detection section 16 are realized, the control program 303 stored in an internal memory device (in the embodiment, the memory 302 in the RAID controller 10) is executed by a microprocessor (in the embodiment, the processor 301) in the computer.

At this time, the computer may read out and execute the program recorded in a recording medium.

In addition, in the embodiment, a computer is a general concept including a piece of hardware and an operating system, and means a piece of hardware that operates under the control of an operating system.

In addition, when an operating system is not necessary and an application program by itself causes the hardware to operate, the hardware itself corresponds to the computer. The hardware includes at least a microprocessor such as a CPU or the like and means for reading out a computer program recorded in a recording medium, and, in the embodiment, the RAID controller 10 includes a function as the computer.

The isolation section 14 performs a control operation for putting the SAS expanders 20 and 25 and the wide links 70 connected to the SAS expanders 20 and 25 into an isolated state in which the SAS expanders 20 and 25 and the wide links 70 are isolated from the storage system 1.

For example, the isolated state is produced by isolating, from a physical or a software viewpoint, the SAS expander 20, the wide link 70 or the like, which relates to a malnutrition, from a data path and putting the SAS expander 20, the wide link 70 or the like into a state in which a data access is impossible.

In addition, such a method in which the isolation section 14 puts the SAS expander 20 or the like into the isolated state can be realized using any one of various kinds of well-known techniques and hence the detailed description thereof will be omitted.

In addition, hereinafter, in some cases, the operation in which a device such as the SAS expander 20 or the like is put into the isolated state is expressed as “isolating” or “degenerating”. In addition, in order to realize the isolated state, electric power supply to the target SAS expander 20 or the like may be shut off. In addition, the isolation processing operation performed by the isolation section 14 can be performed using any one of various kinds of well-known techniques.

In addition, in the storage system 1, when one of the SAS expanders 20 and 25 is isolated, accesses to the SAS expander 20 and the wide link 70 that are located, in the same system, downstream of the isolated expander, are also shut off.

The selection section 11 selects at least one PHYs to be a diagnosis target, as a PHY under selection (physical wiring line under selection), from among a plurality of PHYs (in the embodiment, four PHYs) included in the wide link 70. In addition, the selection of the PHYs under selection may be performed by sequentially selecting the PHYs under selection in a predetermined sequence from among a plurality of selection-target PHYs or by arbitrarily selecting the PHYs under selection from among a plurality of selection-target PHYs. Accordingly, the selection of the PHYs under selection can be performed in any one of various kinds of modified manners. In addition, the selection of the PHYs under selection, performed by the selection section 11, is performed with respect to each of the wide links 70. In addition, in the embodiment, an example in which the selection section 11 selects one PHY as a PHY under selection will be described.

The invalidation section 12 performs a control operation for invalidating the PHYs under selection selected by the selection section 11 and a malfunctioning PHYs (malfunctioning wiring line) certified by the certification section 15 described later. Specifically, the invalidation section 12 isolates a PHY in units of SAS ports, using, for example, a function called “disable”, which is the PHY control function of a serial management protocol (SMP). In addition, the PHY isolation operation is performed by specifying a SAS address.

FIG. 3 is a diagram illustrating a diagnosis method for a PHY, performed in the storage system 1. In an example shown in FIG. 3, with respect to four PHYs #0 to #3, the selection section 11 repeatedly selects one PHY in the following order; PHY #0, PHY #1, PHY #2, PHY #3, PHY #0, . . . , and the invalidation section 12 isolates the selected PHYs.

In addition, in the embodiment, each of PHYs #0 to #3 arranged on the wide link 70 that is cascade-connected so as to be included in the same system, namely, one of the a-system and the b-system, is comprehensively treated.

Specifically, for the wide ports 21 and 22 in each of a plurality of SAS expanders 20 cascade-connected, the invalidation section 12 performs a control operation for simultaneously invalidating PHYs having the same identification number (#0, #1, #2, or #3) among the PHYs #0 to #3.

Accordingly, for example, the PHY #0 on the wide link 70a-1 is comprehensively treated together with individual PHY #0 on the wide links 70a-2 and 70a-3. Namely, when the PHY #0 is isolated (invalidated), all the PHY #0 on the wide links 70a-1, 70a-2, and 70a-3 turn out to be invalidated. In the same way, when the PHY #1 is isolated (invalidated) on the wide link 70 included in the a-system, all the PHY #1 on the wide links 70a-1, 70a-2, and 70a-3 turn out to be invalidated.

In addition, when the PHY #2 is isolated on the wide link 70 included in the a-system, all the PHY #2 on the wide links 70a-1, 70a-2, and 70a-3 turn out to be invalidated. Furthermore, when the PHY #3 is isolated on the wide link 70 included in the a-system, all the PHY #3 on the wide links 70a-1, 70a-2, and 70a-3 turn out to be invalidated.

In addition, the comprehensive treatment for PHYs, in which a plurality of PHYs having the same identification number are simultaneously invalidated on a plurality of cascade-connected wide links 70 is performed for the b-system, in the same way.

Namely, when the PHY #0 is isolated on the wide links 70b-1, 70b-2, and 70b-3 included in the b-system, all the PHY #0 on the wide links 0b-1, 70b-2, and 70b-3 turn out to be invalidated.

In addition, in the same way, when the PHY #1 is isolated on the wide link 70 included in the b-system, all the PHY #1 on the wide links 0b-1, 70b-2, and 70b-3 turn out to be invalidated. In addition, when the PHY #2 is isolated on the wide link 70 included in the b-system, all the PHY #2 on the wide links 0b-1, 70b-2, and 70b-3 turn out to be invalidated. Furthermore, when the PHY #3 is isolated on the wide link 70 included in the b-system, all the PHY #3 on the wide links 0b-1, 70b-2, and 70b-3 turn out to be invalidated.

In addition, the invalidation section 12 preserves information used for specifying an invalidated PHY in a predetermined area in a memory device such as the memory 302 or the like. For example, the preservation of the information is performed by setting a flag for a storage area arranged for each of the PHYs or storing, in a predetermined storage area, information such as an identification number for an invalidated or non-invalidated PHYs, or the like.

Accordingly, in the storage system 1, a PHY invalidated by the invalidation section 12 can be easily recognized.

The confirmation section 13 confirms whether or not, owing to a transmission path malfunction, a data transfer malfunction has occurred in a data transfer operation that uses a PHY other than a PHY under selection invalidated by the invalidation section 12, on the wide link 70. Specifically, with respect to an access control signal (host I/O control signal), generated by the RAID controller 10 on the basis of a host I/O (control signal) transmitted from the higher-level device 4, and an access control signal (test I/O control signal), generated by the access control signal generation section 17 described later, the confirmation section 13 confirms whether or not a transmission path malfunction has occurred in the data transfer operation that uses a PHY other than a PHY under selection invalidated by the invalidation section 12.

Namely, by data-transferring, through a PHY, a host I/O control signal, generated on the basis of a host I/O transmitted from the higher-level device 4 connected to the storage system 1 to the HDD 60, and a test I/O control signal generated by the access control signal generation section 17 described later, the confirmation section 13 confirms whether or not a transmission path malfunction has occurred. In addition, for example, the occurrence of a transmission path malfunction can be confirmed by the reception of no desired response to the transmission of the I/O control signal or the reception of an error signal. In addition, the confirmation of the occurrence of the transmission path malfunction can be realized using any one of various kinds of well-known techniques.

In addition, the confirmation section 13 preserves, in a predetermined area in a memory device such as the memory 302 or the like, the confirmation result relating to whether or not a transmission path malfunction has occurred. For example, the confirmation result is preserved by storing (setting), in a predetermined area, a flag or the like, which indicates whether or not a transmission path malfunction has occurred, so that information used for specifying PHYs used for data transfer (for example, identification information #0 and #1) is related to the flag or the like.

For example, when a data transfer error is detected during a data transfer operation in which the host I/O control signal or the test I/O control signal is transferred through a PHYs, the confirmation section 13 acquires the identification information of a PHYs invalidated by the invalidation section 12 from the memory 302 or the like. In addition, the confirmation section 13 stores information indicating the confirmation result (flag or the like) in the memory 302 or the like so that the confirmation result is related to the identification number.

When, in a state in which a PHYs under selection is invalidated by the invalidation section 12, the confirmation section 13 confirms that a transmission path malfunction has occurred during a data transfer operation that uses a PHYs other than the PHYs under selection, the certification section 15 certifies the PHYs under selection as a normally functioning wiring line. When, in the operation of the storage system 1 performed in a state in which the PHYs under selection is isolated, a transmission path malfunction occurs, it can be determined that the isolated PHYs under selection is safe.

Namely, in the storage system 1, at least one PHY (PHYs under selection) is isolated on a trial basis from among four PHYs included in the wide link 70, the operation of the storage system 1 is performed using the three residual PHYs, and the occurrence of an error is monitored. Accordingly, the PHYs under selection is diagnosed.

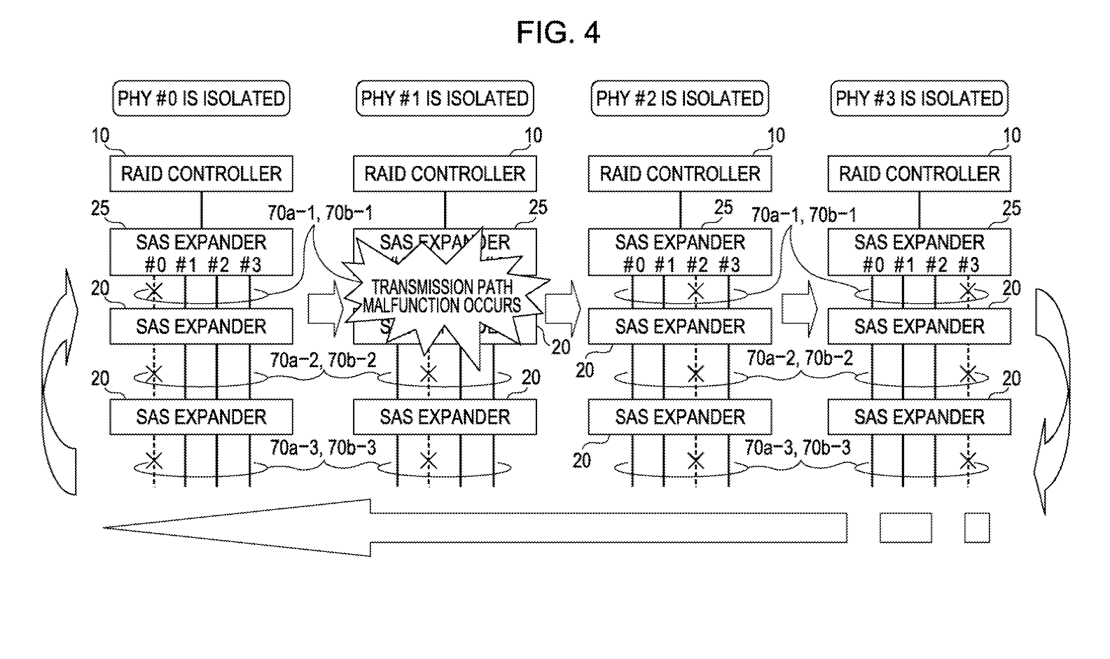

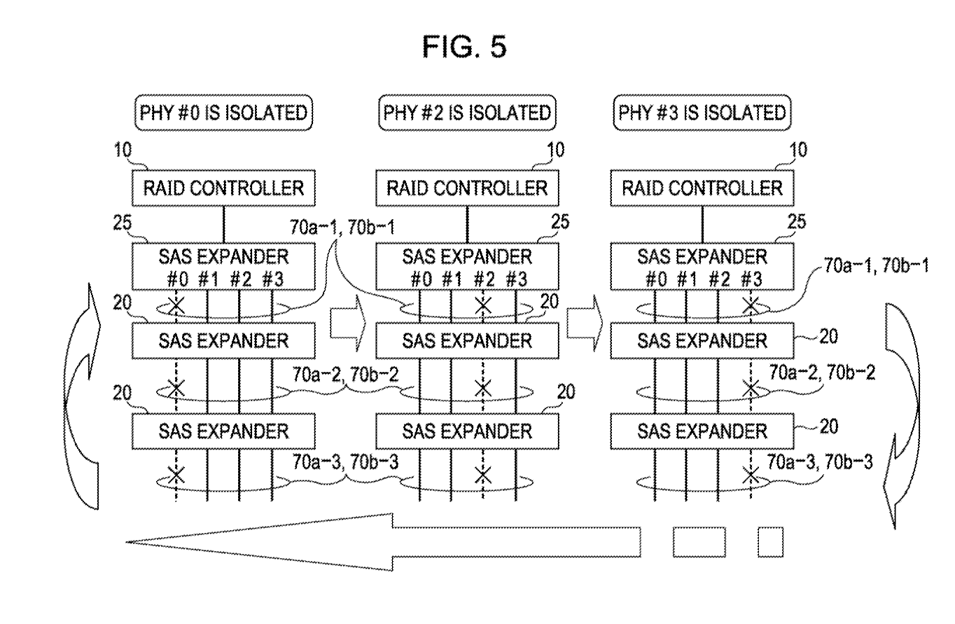

FIGS. 4 and 5 are diagrams illustrating diagnosis methods for PHYs, performed in the storage system 1. Here, FIG. 4 is a diagram illustrating a state where a transmission path malfunction occurs during the operation of the storage system 1 performed in a state in which the PHY #1 is isolated in the example shown in FIG. 3. In addition, FIG. 5 is a diagram illustrating a state where the invalidation section 12 isolates the PHY #1 during the isolation of which a transmission path malfunction is detected in the example shown in FIG. 4.

As shown in FIG. 4, when a transmission path malfunction occurs during the operation of the storage system 1 performed in a state in which the invalidation section 12 isolates the PHY #1 (PHY under selection), it can be determined that the PHY #1 which is a PHY under selection is safe (safe PHY).

In addition, the diagnosis result is stored in a predetermined area in a memory device such as the memory 302 or the like. For example, the confirmation result is preserved by storing (setting), in a predetermined area, a flag or the like, which indicates that an error has occurred or an error has not occurred, so that information used for specifying PHYs under selection (for example, identification information #0 and #1) is related to the flag or the like. Accordingly, it can be easily determined whether or not the PHY under selection is a safe PHY.

The PHY, determined to be safe in this way, is excluded from targets for diagnosis. Namely, the safe PHY is excluded from targets for the isolation operation performed by the invalidation section 12 (an isolated state is cancelled).

In addition, as shown in FIG. 5, one PHY under selection, selected in the same way, is isolated on a trial basis from among the residual unconfirmed PHYs, and the operation of the storage system 1 is performed. By sequentially performing such a processing operation for all the PHYs included in the wide link 70, a safe PHY is put aside and a malfunctioning PHY is specified. Finally, by separating the specified malfunctioning PHY from the storage system 1, the safety of a transmission path (wide link 70) can be ensured. In addition, when the malfunctioning PHY is certified, the certification section 15 certifies as a malfunctioning PHY (malfunctioning wiring line) a PHY that is not certified as a normally functioning wiring line from among a plurality of PHYs included in the wide link 70.

In addition, as mentioned above, the selection of a PHY under selection, performed by the selection section 11, is sequentially performed for all the PHYs included in the wide link 70, and the PHY under selection is switched, for example, every predetermined time, every occurrence of an error, or at a time combining these conditions (every predetermined time and every occurrence of an error).

In addition, for individual PHY under selection, switched in this way, the invalidation of a PHY under selection, performed by the invalidation section 12, and a confirmation operation, in which the confirmation section 13 confirms whether or not a transmission path malfunction has occurred in a data transfer operation that uses PHY other than a PHY under selection, are individually performed.

In addition, the invalidation section 12 invalidates a malfunctioning PHY (malfunctioning wiring line) confirmed by the certification section 15, and, after that, the storage system 1 is operated in a state in which the malfunctioning PHY is invalidated by the invalidation section 12.

In addition, when the confirmation section 13 detects another transmission path malfunction in the operation of the storage system 1, performed in the state in which the malfunctioning PHY is invalidated by the invalidation section 12, the isolation section 14 puts the SAS expander 20 and the wide link 70, which relate to the transmission path malfunction, into an isolated state in which the SAS expander 20 and the wide link 70 are isolated from the storage system 1.

The access control signal generation section 17 generates a test I/O control signal (access control signal) for the HDD 60. The test I/O control signal is a signal used for performing an access control operation for a specific HDD 60 in the same way as the host I/O control signal based on a host I/O supplied from the higher-level device 4, and is a control signal used for reading out and writing data on a trial basis.

The malfunction detection section 16 detects a transmission path malfunction in the host I/O control signal in the storage system 1. For example, the malfunction detection section 16 measures the occurrence frequency of data transfer malfunctions (errors) in the host I/O. In addition, when the occurrence frequency of errors is high, namely, it is detected that the occurrence frequency of communication errors during a predetermined time exceeds a threshold value, it is determined that the errors greatly affect the storage system 1, and hence a transmission path malfunction turns out to be detected.

In addition, when the malfunction detection section 16 detects a transmission path malfunction, the isolation section 14 puts the SAS expander 20 and the wide link 70 or the like, which relates to the failure, into an isolated state.

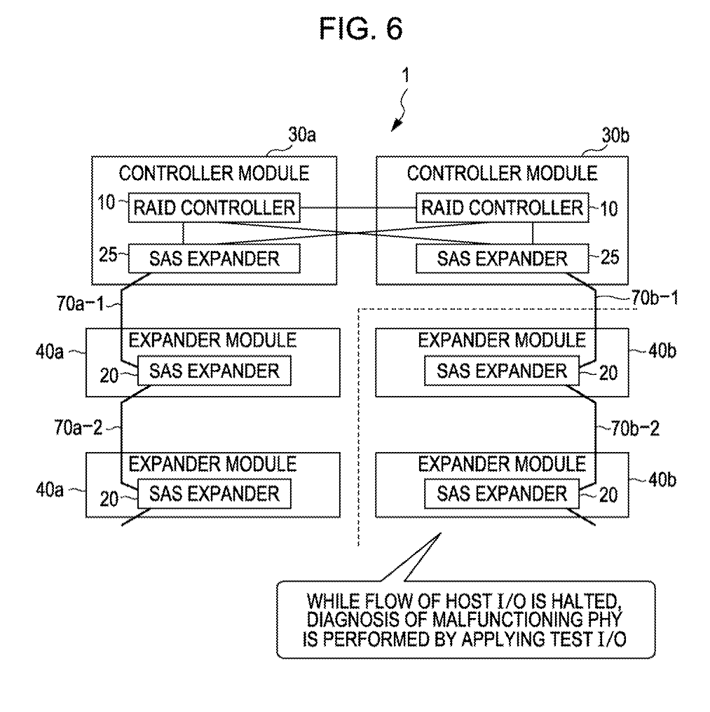

FIG. 6 is a diagram illustrating a state in which an isolation operation is performed in the storage system 1, and illustrates a state in which the expander modules 40b and 40b located downstream of the controller module 30b is isolated.

In this way, by isolating the expander module 40b, a host I/O (disk I/O) is not transmitted to the SAS expanders 20 and the wide links 70, which relate to the expander modules 40b.

In addition, when the SAS expanders 20 are put into an isolated state in this way, the operation of the storage system 1 is performed using portions other than the isolated SAS expanders 20.

In addition, while the operation of the storage system 1 is performed using portions other than the isolated SAS expanders 20, the storage system 1 includes a diagnosis function for diagnosing whether or not a PHY, arranged on the wide links 70 included in an area isolated by the isolation section 14, is available for data communication.

By diagnosing PHYs, arranged on the wide links 70, for the isolated SAS expanders 20 while the storage system 1 is operated, a malfunctioning PHY can be quickly specified. Accordingly, by isolating only the malfunctioning PHYs arranged on the wide link 70 and operating the storage system 1, the occurrence of data transfer errors in the host I/O can be reduced.

Specifically, the selection section 11 also selects one PHY as a PHY under selection from among a plurality of PHYs included in the wide link 70 that is included in an area degenerated by the isolation section 14.

In addition, when, in this way, the wide link 70 that is a target for diagnosis is included in the area degenerated by the isolation section 14, the confirmation section 13 data-transfers, in place of the host I/O transmitted from the higher-level device 4, the test I/O control signal (access control signal), generated by the access control signal generation section 17, through a PHY other than a PHY under selection invalidated by the invalidation section 12. Accordingly, the confirmation section 13 confirms whether or not a data transfer malfunction has occurred owing to a transmission path malfunction.

When, in a state in which a PHY under selection is invalidated by the invalidation section 12, the confirmation section 13 confirms the occurrence of a transmission path malfunction during a data transfer operation that uses a PHY other than the PHY under selection, the certification section 15 certifies the PHY under selection as a normally functioning wiring line. In addition, the certification section 15 certifies a PHY, which is not certified, as a normally functioning wiring line, from among a plurality of PHYs included in the wide link 70, as a malfunctioning PHYs. In addition, the selection of the PHYs under selection, performed by the selection section 11, is sequentially performed for all the PHYs included in the wide link 70 that is a target for diagnosis, and the PHYs under selection is switched, for example, every predetermined time. In addition, for individual PHY under selection, switched in this way, the invalidation of a PHY under selection, performed by the invalidation section 12, and a confirmation operation, in which the confirmation section 13 confirms whether or not a transmission path malfunction has occurred in a data transfer operation that uses PHYs other than a PHY under selection, are individually performed.

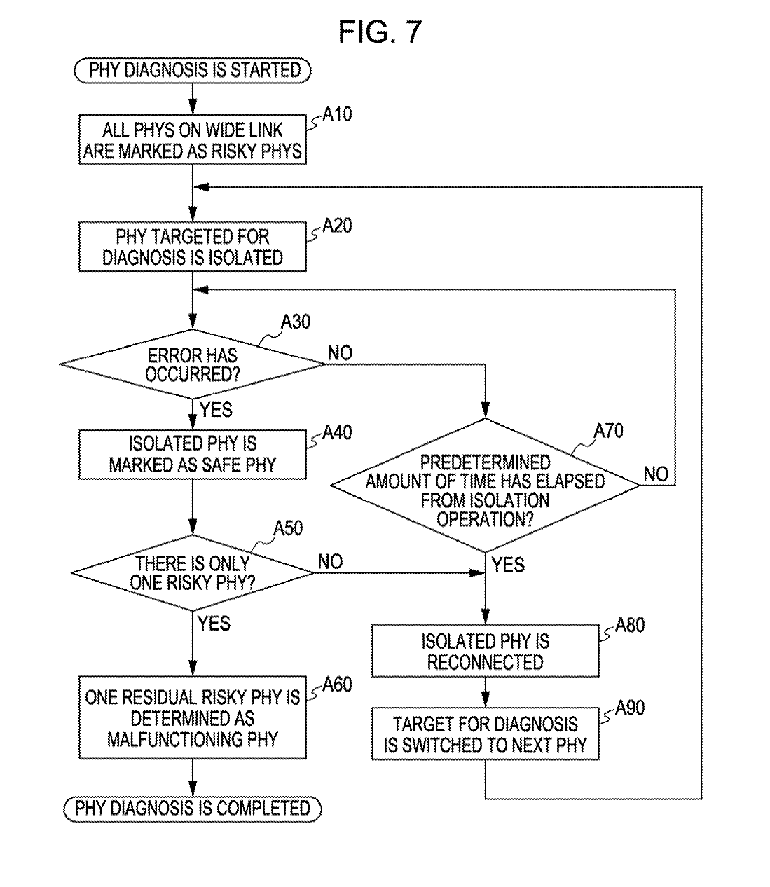

A diagnosis method for a PHY, performed in a storage system 1 configured in the way mentioned above, will be described with reference to a flowchart shown in FIGS. 7 (A10 to A90).

When a PHY is diagnosed, the selection section 11 performs, for example, a setting (mark), which indicates “risky PHYs” for all the PHYs arranged on the wide link 70 (A10). For example, the mark indicating “risky PHYs” is assigned by setting an arbitrary flag in predetermined areas in a memory area such as a memory or the like, which is not shown, the predetermined areas corresponding to PHYs respectively.

In addition, the selection section 11 selects one PHY, which has not been diagnosed, from among a plurality of PHY included in the wide link 70 (A10: selection step), and the invalidation section 12 isolates the selected PHY under selection (A20: invalidation step).

While the storage system 1 is operated for a predetermined time in a state in which the PHY under selection is isolated in this way (one PHY isolated state), the confirmation section 13 confirms whether or not a transmission malfunction (error) in the host I/O has occurred in the operation performed in the one PHYs isolated state (A30: confirmation step).

As the confirmation result obtained by the confirmation section 13, when an error occurs (refer to YES route in A30), the certification section 15 cancels the mark indicating “risky PHYs” for the PHYs under selection and assigns a mark indicating “safe PHY” to the PHYs under selection (A40: certification step). In addition, the mark indicating “safe PHY” also is assigned by setting an arbitrary flag in predetermined areas in a memory area such as a memory or the like, which is not shown, the predetermined areas corresponding to PHYs respectively.

In addition, the certification section 15 confirms the number of risky PHYs on the wide link 70 that is a target for diagnosis, and confirms whether or not there is only one risky PHY (A50). As the confirmation result, when there is only one risky PHY (refer to YES route in A50), the certification section 15 determines that the residual risky PHY is a malfunctioning PHY (A60: malfunction certification step), and terminates the processing operation.

On the other hand, when a transmission malfunction (error) in the host I/O has not occurred in the operation performed in the one PHYs isolated state (refer to NO route in A30), next the confirmation section 13 confirms a time having elapsed from the isolation of the PHYs under selection performed by the invalidation section 12 (A70). As the confirmation result, when a predetermined amount of time has not elapsed (refer to NO route in A70), the processing operation returns to A30.

In addition, when a predetermined amount of time has elapsed from the isolation of the PHYs under selection (refer to YES route in A70), the invalidation section 12 cancels the invalidation of the PHYs under selection, and reconnects the isolated PHYs under selection (A80). In addition, by selecting another PHY as a PHY under selection, the selection section 11 switches a PHY that is a target for diagnosis (A90), and the processing operation returns to A20.

Furthermore, when there are more than one risky PHY (refer to NO route in A50), the processing operation proceeds to A80.

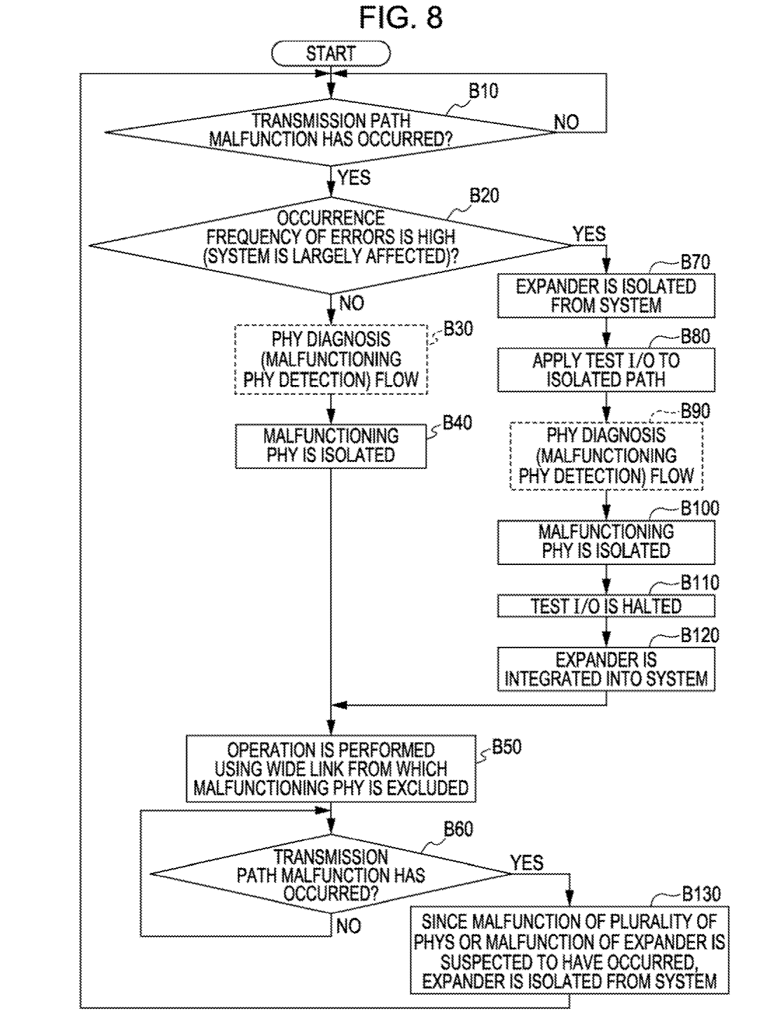

Next, a processing operation performed when a transmission path malfunction occurs during the operation of the storage system 1 will be described with reference to a flowchart shown in FIGS. 8 (B10 to B130).

During the operation of the storage system 1, the processor 301 in the RAID controller 10 constantly monitors whether or not a transmission path malfunction has occurred (refer to B10 and NO route in B10). In addition, when the occurrence of a transmission path malfunction is detected (refer to YES route in B10), next the processor 301 confirms the occurrence frequency of the transmission path malfunctions (B20). Namely, the processor 301 determines whether or not the detected transmission path malfunctions greatly affect the storage system 1.

Here, when, regarding the detected transmission path malfunctions, the occurrence frequency of errors is low, namely, the occurrence frequency of errors does not greatly affect the storage system 1 (refer to NO route in B20), a diagnosis processing operation for detecting a malfunctioning PHYs is performed (B30). Specifically, the RAID controller 10 performs a PHYs diagnosis processing operation (refer to A10 to A90), described above with reference to FIG. 7.

In addition, the invalidation section 12 isolates a PHY diagnosed as a malfunctioning PHY in A60 in the PHY diagnosis processing operation (B40), and the operation of the storage system 1 is performed using the wide link 70 on which the malfunctioning PHY is invalidated (B50).

The RAID controller 10 constantly monitors whether or not a transmission path malfunction has occurred in the operation in which the malfunctioning PHY is invalidated (refer to B60 and NO route in B60). In addition, when the occurrence of a transmission path malfunction is detected (refer to YES route in B60), the invalidation section 12 isolates the corresponding SAS expander 20 or the like (B130), and the processing operation returns to B10.

Here, regarding the reason why the corresponding SAS expander 20 or the like is isolated, another transmission path malfunction, detected in a state in which a malfunctioning PHY is invalidated, is suspected to occur owing to the malfunction of a plurality of PHYs arranged on the wide link 70 or some kind of malfunction existing in the SAS expander 20.

In addition, through the higher-level device 4, a management device, which is not shown, or the like, an administrator of the storage system 1 is informed that the SAS expander 20 or the like is isolated. At a predetermined time, the administrator performs maintenance work on the expander module 40 and the wide link 70 that are isolated.

On the other hand, when, regarding the detected transmission path malfunctions, the occurrence frequency of errors is high, namely, the occurrence frequency of errors greatly affects the storage system 1 (refer to YES route in B20), the isolation section 14 puts the target expander module 40 (SAS expander 20) into an isolated state, and hence isolates the target expander module 40 (SAS expander 20) so that the host I/O control signal does not flow to the SAS expander 20 that is a target for isolation (B70).

The RAID controller 10 causes the access control signal generation section 17 to generate the test I/O control signal, and applies the generated I/O control signal to the SAS expander 20 that is a target for isolation (B80). In addition, using the test I/O control signal, a diagnosis processing operation for detecting a malfunctioning PHY in the SAS expander 20 that is a target for isolation is performed (B90). Specifically, using, in place of the host I/O control signal, the test I/O control signal generated by the access control signal generation section 17, the RAID controller 10 performs the PHY diagnosis processing operation (refer to A10 to A90), described above with reference to FIG. 7.

In addition, the invalidation section 12 isolates a PHY diagnosed as a malfunctioning PHY in Step A60 in the PHY diagnosis processing operation (B100). The RAID controller 10 causes the access control signal generation section 17 to halt the generation of the test I/O control signal (B110), and again integrates the SAS expander 20, put into the isolated state by the isolation section 14, into the storage system 1 (B120). After that, the processing operation proceeds to Step B5. Namely, the operation of the storage system 1 that uses the wide link 70 on which a malfunctioning PHY is invalidated is performed.

In this way, in the storage system 1 according to an embodiment of the present invention, the operation of the storage system 1 is performed in a state in which the invalidation section 12 invalidates a PHY under selection, selected from among a plurality of PHYs included in the wide link 70. In addition, when a transmission path malfunction is detected during the operation of the storage system 1, the PHY under selection is certified as a normally functioning wiring line. Accordingly, a normally functioning PHY on the wide link 70 can be specified.

In addition, by sequentially performing the certification processing operation, in which the PHY under selection is certified as a normally functioning wiring line, for all the PHY included in the wide link 70, a malfunctioning PHY on the wide link 70 can be specified and put aside. Namely, a diagnosis processing operation for individual PHY included in the wide link 70 can be easily and certainly performed, and hence convenience is high.

In addition, the above-mentioned diagnosis processing operation for PHYs arranged on the wide links 70 is performed using the host I/O control signal based on the host I/O supplied from the higher-level device 4. Accordingly, the diagnosis processing operation for PHYs arranged on the wide links 70 can be performed while the operation of the storage system 1 is performed.

Furthermore, even if a malfunctioning PHY is detected on the wide link 70, the invalidation section 12 invalidates only the malfunctioning PHYs, and the storage system 1 is operated using other safe PHYs included in the wide link 70. Accordingly, without isolating the entire wide link 70 that includes the malfunctioning PHYs and the isolation of the SAS expander 20, the storage system 1 can continue to be operated. Therefore, while the redundancy of the storage system 1 is maintained and the I/O performance thereof is not greatly reduced, the storage system 1 can be operated.

In addition, regarding the SAS expander 20, put into an isolated state by the isolation section 14 owing to the frequent detection of transmission path malfunctions or the like, a diagnosis processing operation for detecting a malfunctioning PHY can be performed using, in place of the host I/O control signal, the test I/O control signal generated by the access control signal generation section 17.

Namely, regarding the SAS expander 20, put into an isolated state, a test I/O is transmitted in a state in which the invalidation section 12 invalidates a PHY under selection, selected from among a plurality of PHYs included in the wide link 70. When a transmission path malfunction is detected during the test I/O transmission, the PHY under selection is certified as a normally functioning wiring line. Accordingly, a normally functioning PHY on the wide link 70 can be specified.

In addition, by sequentially performing the certification processing operation, in which the PHY under selection is certified as a normally functioning wiring line, for all the PHYs included in the wide link 70 put into an isolated state, a malfunctioning PHY on the wide link 70 can be specified and put aside. Namely, in the storage system 1, also regarding the isolated SAS expander 20, a diagnosis processing operation for individual PHY included in the wide link 70 connected to the SAS expander 20 can be easily and certainly performed, and hence convenience is high.

Furthermore, when a malfunctioning PHY is specified in the SAS expander 20 that is a target for isolation, the invalidation section 12 invalidates only the malfunctioning PHY, and again the corresponding SAS expander 20 is integrated into the storage system 1 to operate the storage system 1. Accordingly, without isolating the entire wide link 70 that includes the malfunctioning PHYs and the isolation of the SAS expander 20, the storage system 1 can continue to be operated. Therefore, while the redundancy of the storage system 1 is maintained and the I/O performance thereof is not greatly reduced, the storage system 1 can be operated.

In addition, when a malfunctioning PHY is not specified in the SAS expander 20 that is a target for isolation, the RAID controller 10 determines that a disk malfunction has occurred, and regards the SAS expander 20 as a target for repair and maintenance and does not integrate the SAS expander 20 into the storage system 1. Accordingly, the transmission path malfunction can be certainly resolved.

In addition, disclosed techniques are not limited to the embodiments described above, and modifications of or alternatives to the embodiments can be made by those skilled in the art without departing from the scope of the present invention.

For example, while, in the embodiments described above, an example in which the storage system 1 includes two drive enclosures 3-1 and 3-2 is shown, the embodiments are not limited to this example and the storage system 1 may include one drive enclosure or more than two drive enclosures.

In addition, while, in the embodiments described above, the storage system 1 having a redundant configuration in which the a-system and the b-system are included is shown, the embodiments are not limited to this configuration and the storage system 1 may have a redundant configuration in which more than two systems are included.

Furthermore, in the embodiments described above, each of PHYs #0 to #3 arranged on the wide link 70 that is cascade-connected so as to be included in the same system is comprehensively treated. Namely, while, for the wide ports 21 and 22 in each of a plurality of SAS expanders 20 cascade-connected, the invalidation section 12 performs a control operation for simultaneously invalidating PHYs having the same identification number (#0, #1, #2, or #3) among the PHYs #0 to #3, disclosed techniques are not limited to the example.

For example, for the wide ports 21 and 22 in one of the plurality of SAS expanders 20 cascade-connected, the invalidation section 12 may perform a control operation for individually invalidating PHYs having the same identification number (#0, #1, #2, or #3) among the PHYs #0 to #3.

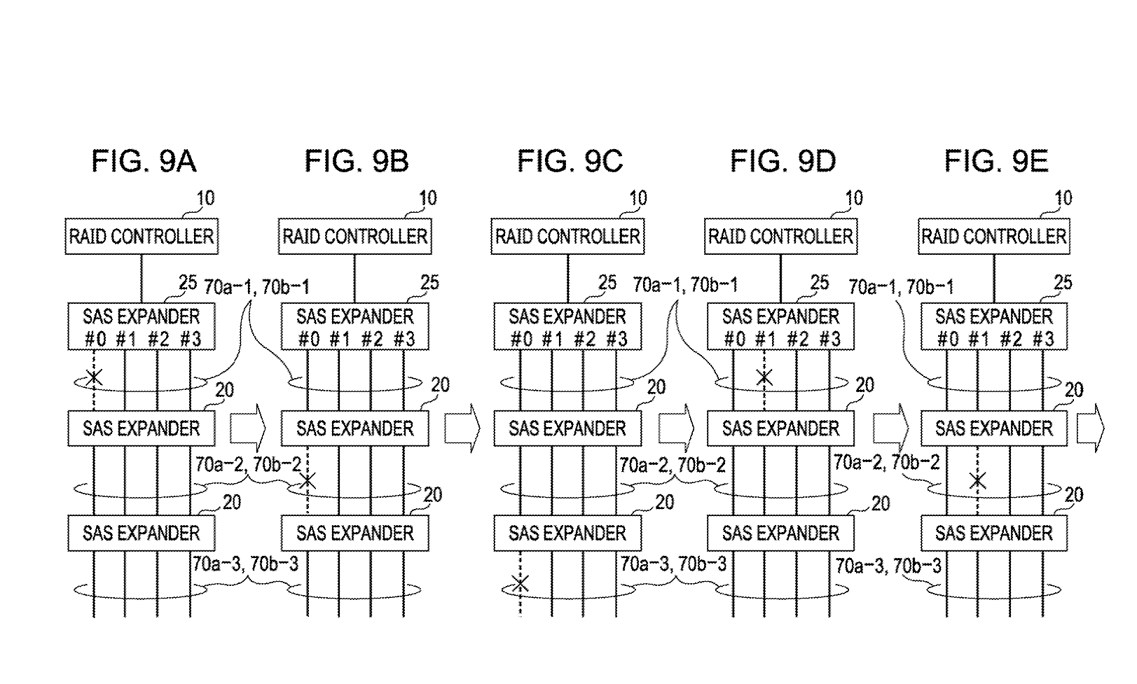

FIGS. 9A to 9E are diagrams illustrating a modified example of a diagnosis method for a PHY, performed in the storage system 1.

In the modified example, first, diagnosis processing operations for PHY #0 arranged on all the wide links 70 in the same system are performed.

First, as shown in FIG. 9A, in a state in which the selection section 11 selects, as a PHY under selection, only the PHY #0 arranged on the wide link 70a-1 (or 70b-1) and the invalidation section 12 invalidates the selected PHY under selection, the host I/O control signal or the test I/O control signal is transmitted and it is determined whether or not a transmission path malfunction has occurred. Accordingly, the diagnosis processing operation for the PHY under selection is performed.

Here, when a transmission path malfunction is detected during the transmission of the host I/O or the test I/O performed in a state in which the PHY under selection is isolated, it can be determined that the PHY #0 arranged on the wide link 70a-1 (or 70b-1), which is the PHY under selection, is a safe PHY.

Next, as shown in FIG. 9B, in a state in which the selection section 11 selects, as a PHY under selection, only the PHY #0 arranged on the wide link 70a-2 (or 70b-2) and the invalidation section 12 invalidates the selected PHY under selection, the host I/O control signal or the test I/O control signal is transmitted and it is determined whether or not a transmission path malfunction has occurred. Accordingly, the diagnosis processing operation for the PHY under selection is performed.

Hereinafter, in the same way, as shown in FIG. 9C, in a state in which the selection section 11 selects, as a PHY under selection, only the PHY #0 arranged on the wide link 70a-3 (or 70b-3) and the invalidation section 12 invalidates the selected PHY under selection, the host I/O control signal or the test I/O control signal is transmitted and it is determined whether or not a transmission path malfunction has occurred. Accordingly, the diagnosis processing operation for the PHY under selection is performed.

In addition, after the diagnosis processing operations for PHY #0 arranged on all the wide links 70 in the same system have been performed, next, diagnosis processing operations for PHY #1 arranged on all the wide links 70 in the same system are performed.

Namely, as shown in FIG. 9D, in a state in which the selection section 11 selects, as a PHY under selection, only the PHY #1 arranged on the wide link 70a-1 (or 70b-1) and the invalidation section 12 invalidates the selected PHY under selection, the host I/O control signal or the test I/O control signal is transmitted and it is determined whether or not a transmission path malfunction has occurred. Accordingly, the diagnosis processing operation for the PHY under selection is performed.

Next, as shown in FIG. 9E, in a state in which the selection section 11 selects, as a PHY under selection, only the PHY #1 arranged on the wide link 70a-2 (or 70b-2) and the invalidation section 12 invalidates the selected PHY under selection, the host I/O control signal or the test I/O control signal is transmitted and it is determined whether or not a transmission path malfunction has occurred. Accordingly, the diagnosis processing operation for the PHY under selection is performed.

Hereinafter, in the same way, individual diagnosis processing operations for the PHY #1 arranged on individual wide links 70 are sequentially performed, and furthermore, individual diagnosis processing operations for the PHY #2 and the PHY #3 arranged on individual wide links 70 are sequentially performed.

In this way, one selected PHY under selection is isolated on a trial basis from among the unconfirmed PHY arranged on the wide link 70 in the storage system 1, and the operation of the storage system 1 is performed. By sequentially performing such a processing operation for all the PHYs included in the wide link 70, a safe PHY is put aside and a malfunctioning PHY is specified.

Accordingly, on an arbitrary wide link 70 selected from among a plurality of wide links 70a-1, 70a-2, 70a-3, 70b-1, 70b-2, and 70b-3, an arbitrary PHY can be selectively invalidated.

In this way, by partially invalidating a PHY on any one of a plurality of cascade-connected wide links 70a-1, 70a-2, and 70a-3 (70b-1, 70b-2, and 70b-3), the position of a malfunctioning PHY can be strictly specified, and hence convenience is high.

As mentioned above, owing to the storage system, the control device, and the diagnosis method, disclosed, the following advantageous effects are obtained.

(1) A normally functioning physical wiring line is specified in parallel wiring lines.

(2) The diagnosis for individual physical wiring lines included in parallel wiring lines can be easily and certainly performed, and hence convenience is high.

(3) While the redundancy of the storage system is maintained and the I/O performance thereof is not greatly reduced, the storage system can be operated.

In addition, with the disclosure described above, those skilled in the art can implement and manufacture the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a storage device; and
a control device configured to access the storage device through one of a plurality of physical wiring lines, the control device including,
a selection section configured to select at least one of the plurality of physical wiring lines,
an invalidation section configured to invalidate the selected physical wiring line,
a detection section configured to detect whether there is an abnormal transmission or not in a data transfer that uses the physical wiring line other than the invalidated physical wiring line, and
a confirmation section configured to confirm the selected physical wiring line as a normal wiring line, when the detection section detects the occurrence of the abnormal transmission.

2. The storage system of claim 1, wherein the detection section detects whether the abnormal transmission occurs or not in the data transfer that uses the physical wiring line other than the invalidated physical wiring line, based on a result of the data transfer executed for responding to an access control signal transmitted from a higher-level device.

3. The storage system of claim 1, further comprising:
an access control signal generation section which generates an access control signal for diagnosing the storage device,
wherein the detection section detects whether the abnormal transmission occurs or not in the data transfer that uses the physical wiring line other than the invalidated physical wiring line, based on a result of the data transfer executed for responding to an access control signal generated by the access control signal generation section.

4. The storage system of claim 1, further comprising:
an isolation section configured to put the storage device into a state of isolation from the storage system, wherein the invalidation section further executes a status inversion of the physical wiring lines, the status inversion including validation of the normal wiring line and invalidation of all the physical wiring lines other than the normal wiring line, and
the isolation section puts the storage device related to the physical wiring lines into the state of isolation from the storage system when the detection section detects the occurrence of the abnormal transmission after the status inversion of the physical wiring lines.

5. A control device for accessing a storage device through one of a plurality of physical wiring lines in a storage system, the control device comprising:
a selection section configured to select at least one of the plurality of physical wiring lines;
an invalidation section configured to invalidate the selected physical wiring line;
a detection section configured to detect whether there is an abnormal transmission or not in a data transfer that uses the physical wiring line other than the invalidated physical wiring line; and
a confirmation section configured to confirm the selected physical wiring line as a normal wiring line, when the detection section detects the occurrence of the abnormal transmission.

6. The control device of claim 5, wherein the detection section detects whether the abnormal transmission occurs or not in the data transfer that uses the physical wiring line other than the invalidated physical wiring line, based on a result of the data transfer executed for responding to an access control signal transmitted from a higher-level device.

7. The control device of claim 5, further comprising:
an access control signal generation section which generates an access control signal for diagnosing the storage device,
wherein the detection section detects whether the abnormal transmission occurs or not in the data transfer that uses the physical wiring line other than the invalidated physical wiring line, based on a result of the data transfer executed for responding to an access control signal generated by the access control signal generation section.

8. The control device of claim 5, further comprising:
an isolation section configured to put the storage device into a state of isolation from the storage system, wherein the invalidation section further executes a status inversion of the physical wiring lines, the status inversion including validation of the normal wiring line and invalidation of all the physical wiring lines other than the normal wiring line, and
the isolation section puts the storage device related to the physical wiring lines into the state of isolation from the storage system when the detection section detects the occurrence of the abnormal transmission after the status inversion of the physical wiring lines.

9. A method for diagnosing connection to a storage device included in a storage system, the method being executed by a control device configured to access the storage device through one of a plurality of physical wiring lines, the method comprising:
selecting at least one of two or more physical wiring lines;
invalidating the selected physical wiring line;
detecting whether there is an abnormal transmission or not in a data transfer that uses the physical wiring line other than the invalid physical wiring line; and
confirming, by the control device, the selected physical wiring line as a normal wiring line, when the occurrence of the abnormal transmission is detected.

10. The method of claim 9, wherein the control device detects whether the abnormal transmission occurs or not in the data transfer that uses the physical wiring line other than the invalidated physical wiring line, based on a result of the data transfer executed for responding to an access control signal transmitted from a higher-level device.

11. The method of claim 9, further comprising:
generating an access control signal for diagnosing the storage device,
wherein the control device detects whether the abnormal transmission occurs or not in the data transfer that uses the physical wiring line other than the invalidated physical wiring line, based on a result of the data transfer executed for responding to the access control signal generated by the control device.

12. The method of claim 9, further comprising:
executing a status inversion of the physical wiring lines, the status inversion including validation of the normal wiring line and invalidation of all the physical wiring lines other than the normal wiring line, and
putting the storage device related to the physical wiring lines into the state of isolation from the storage system when the detection section detects the occurrence of the abnormal transmission after the status inversion of the physical wiring lines.

13. A non-transitory computer-readable recording medium recorded with a diagnostic program for diagnosing connection to a storage device included in a storage system, the diagnostic program causing a computer accessing the storage device through one of a plurality of physical wiring lines to execute:
selecting at least one of two or more physical wiring lines;
invalidating the selected physical wiring line;
detecting whether there is an abnormal transmission or not in a data transfer that uses the physical wiring line other than the invalid physical wiring line; and
confirming the selected physical wiring line as a normal wiring line, when the occurrence of the abnormal transmission is detected.

14. The non-transitory computer-readable recording medium of claim 13, wherein the diagnostic program causes the computer to detect whether the abnormal transmission is occurred or not, based on the data transfer result executed for responding to an access control signal transmitted from a higher-level device.

15. The non-transitory computer-readable recording medium of claim 13, the diagnostic program further causing the computer to execute:
generating an access control signal for diagnosing the storage device,
wherein the computer detects whether the abnormal transmission occurs or not in the data transfer that uses the physical wiring line other than the invalidated physical wiring line, based on a result of the data transfer executed for responding to the access control signal generated by the computer.

16. The non-transitory computer-readable recording medium of claim 13, the diagnostic program further causing the computer to execute:
executing a status inversion of the physical wiring lines, the status inversion including validation of the normal wiring line and invalidation of all the physical wiring lines other than the normal wiring line, and
putting the storage device related to the physical wiring lines into the state of isolation from the storage system when the detection section detects the occurrence of the abnormal transmission after the status inversion of the physical wiring lines.
